(19) United States
(12) Patent Application Publication
(10) Pub. No.: US 2014/0120517 A1
(43) Pub. Date: May 1, 2014

(54) CHALLENGE BASED INNOVATION SYSTEM

(71) Applicant: Nicholas J. WEBB, Redding, CA (US)

(72) Inventor: Nicholas J. WEBB, Redding, CA (US)

(21) Appl. No.: 14/068,313

(22) Filed: Oct. 31, 2013

Related U.S. Application Data
(60) Provisional application No. 61/720,671, filed on Oct. 31, 2012.

(51) Int. Cl. A63H 33/04; G09B 5/00

(52) U.S. Cl. CPC A63H 33/04; G09B 5/00
USPC 434/365

(57) ABSTRACT

A challenge-based innovation kit includes a first piece and a second piece. The first piece includes a hub member and a wheel member. The wheel member is rotatably coupled to the hub member. The hub member defines a first mount portion. The wheel member defines a second mount portion opposing the first mount portion. The second piece includes a plurality of third mount portions for coupling the second piece to the first mount portion or the second mount portion.

### CROSS-REFERENCE TO RELATED APPLICATIONS

This application claims the benefit of U.S. Provisional Application No. 61/720,671, filed on Oct. 31, 2012. The entire disclosure of the above application is incorporated herein by reference.

### FIELD

The present disclosure relates to a challenge-based innovation system.

### BACKGROUND

Building blocks and building toys have been around for centuries. The two most common types of building toys are first, toys that come with instructions and are designed to create a character or a predetermined structure such as a car or tractor. The second type of toys is building blocks that allow children and adults to create arbitrary structures using their own imagination and creativity. The first type is essentially nothing more than a three-dimensional puzzle. The developmental skills behind such a toy are really developing the expertise of following written or pictorial instructions. Although the second form stimulates far more creative thinking, it doesn't actually develop innovation and creative skills because there is no targeted objective associated with the free styling approach of block building.

### SUMMARY

This section provides a general summary of the disclosure, and is not a comprehensive disclosure of its full scope or all of its features.

In one configuration, the present disclosure provides a challenge-based innovation kit. The kit includes a first piece and a second piece. The first piece includes a hub member and a wheel member. The wheel member is rotatably coupled to the hub member. The hub member defines a first mount portion. The wheel member defines a second mount portion opposing the first mount portion. The second piece includes a plurality of third mount portions for coupling the second piece to the first mount portion or the second mount portion.

In another configuration, the present disclosure provides a method of conducting a challenge-based innovation system. The method includes providing a plurality of users, including a leader. The method also includes providing each user with a challenge-based innovation kit including a plurality of interconnectable first pieces and second pieces. The method additionally includes posting a challenge assignment to a digital interface and building a structure to solve the challenge assignment by interconnecting the first and second pieces. The method also includes working on solving the challenge assignment for a predetermined amount of time. The method further includes utilizing a third party to judge the structures and create a list of results, including a winning structure and losing structures. The method also includes posting the results to the digital interface providing redeemable credits to the winning structure.

The Hanz™ System is a construction set comprised of multiple numbers of the basic components: Brain, Beam, Sprocket Wheel and Tire. Unlike toy sets such as Lego that come with step-by-step pictorial instructions, the Hanz System is specifically designed to teach innovation, collaboration, competition, and creativity skills. Construction sets that come complete with instruction manuals teach children to replicate, not innovate. Research shows that challenge-based innovation that uses game dynamics and community-based socialization significantly increase collaboration, engagement, and innovation success.

Correspondingly, the system also includes digital components such as an interactive website and smart a phone app. The website is the innovation community platform. On this platform, challenges (e.g., assignments) are posted in a variety of categories as artistic, architectural, engineering and green/environmental/Eco-friendly challenge by way of non-limiting example. These challenges are further broken down by age groups and/or grade level. There is also a college challenge for undergraduate and graduate schools. Each grade level or grade level grouping is managed by a community leader that provides resources to the various competition teams. Teams have a set period of time, e.g., 1 hour, 1 day, 1 week, 1 year, to create their challenge invention and submit them for judging. In addition to a challenge, the website posts monthly challenges in all four categories. Additionally, community members can post public or private challenges themselves and determine who can participate in private and public challenges. Game mechanics will be deployed to the innovation community in order to drive engagement and participation. Participants will be able to earn credits that are redeemable for free products or services. There are three ways in which participants can earn credits. Community members that post the most challenges will earn the most credits for free products or services at the end of a designated time period. They will also earn the moniker Innovation Superstar™. Secondly, community members that submit the most innovations will earn the most credits for free products or services. They will also earn the moniker Innovation Superstar™.

Lastly, the website will also include a social network and a leaderboard. Credits will be awarded to community members that have the highest level of participation through posting. Another important aspect of the social dynamic in this community is recognition. Other features that promote the Innovation Superstars™ including certificates and notoriety. The platform requires user registration. Once the user is registered they can apply to participate in any open challenge. As registered users, they can also post daily flash challenges for other community members to attempt to invent solutions, too. Additionally, registered users can post open challenges that are available to the general public of registered users or they can post private challenges and allow only select users to participate by permission. The website will also have an open portfolio. This is an area where inventors can post their most recent projects. The website will also have a video channel that allows users to submit videos of a functional build to be posted on the TV channel for public viewing.

Hanz for Business, is an important iteration of the product and its corresponding digital counterpart to be used as a training resource for business. The training component articulates a business challenge for a client company then their workforce collaborates around the stated challenge to learn several developmental leadership skills. These skills include creativity, problem-solving, workforce collaboration, innovation best practice, teamwork and fundamental innovation best practice. Each challenge will also be broken down by kit sizes. There are three competition kits, the nano kit, the micro kit and a mega kit. In order to make the competition fair, competitors must compete based on kit size. Additionally, inventors that want to share their innovation plans can use a channel numbering system, such as that shown on page 6, for example, as a way to share the way in which they built their kit. As for the hardware components, there are three circular holes in the brain, each circular hole has four positions and the brain also allows planks to be disposed perpendicular to the brain. The design also allows the brains to connect to each other either at a 90 degree angle or along their longitudinal axis.

Three of the components, namely, the sprocket or hub, the wheel and the tire make up a wheel assembly. The hub assembly is removably attached to the brain structure, and can be positioned in any of the three plugs located on the brain structure. The brain structure is comprised of an elongate flattened plastic or other resilient material and includes three plug-in areas. The plug in areas are provided with notches that receive the beam structures in order to create strong models with several positioning options. Each plug has four channel positions options and the included instructions provide graduations to each channel position so as to allow the user to record either digitally or by manual means the various positions of the plank and wheel so as to share their innovations structure with others and record it should they wish to build it again. The brain also has an elongated channel on both the vertical and horizontal edge of the brain structure. This allows the user to connect the brains in a parallel fashion or along the vertical structure so as to create both a box structure and an L-shaped structure. The brain structure also includes eight outer notches that allow the beams to connect to the outer aspect of the brain structure.

The primary theme of the Hanz system is that it is a resource to get America inventing again by engaging children, high school students, and adults in the sciences. The product has a unique design which removed approximately 60% of the plastic making the device extremely eco-sensitive. The product was designed in California and is manufactured in the United States of America.

The innovation platform can create thousands of innovative embodiments from kits including just three major components; brains, beams and wheel assemblies.

The innovation platform provides a universal challenge platform that can support a substantial number of potential challenges. The innovation platform is a workforce collaboration tool. The innovation platform teaches creativity, teamwork, innovation principles, leadership, problem solving and collaboration.

### DRAWINGS

The drawings described herein are for illustrative purposes only of selected embodiments and not all possible implementations, and are not intended to limit the scope of the present disclosure.

FIG. 1 is a perspective view of a wheel member of a construction piece in accordance with the teachings of the present disclosure;

FIG. 2 is a side view of the wheel member of FIG. 1;

FIG. 3 is an end view of the wheel member of FIG. 1;

FIG. 4 is a perspective view of a hub member of a construction piece in accordance with the teachings of the present disclosure;

FIG. 5 is a side view of the hub member of FIG. 4;

FIG. 6 is an end view of the hub member of FIG. 4;

FIG. 7 is a perspective view of a support member in accordance with the teachings of the present disclosure;

FIG. 8 is an end view of the support member of FIG. 7;

FIG. 9 is a side view of the support member of FIG. 7;

FIG. 10 is another end view of the support member of FIG. 7;

FIG. 11 is an exploded view of a wheel assembly and a support member in accordance with the teachings of the present disclosure; and

FIG. 12 is an assembled view of a wheel assembly, a support member, and another construction piece in accordance with the teachings of the present disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

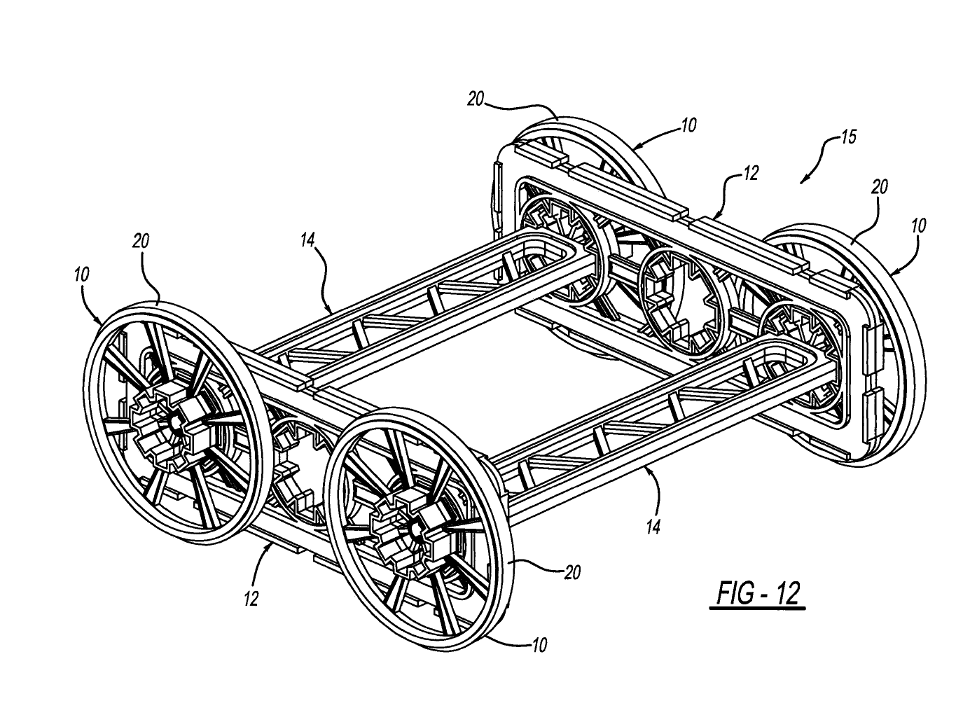

With general reference to the figures, first and second construction pieces 10, 12 in accordance with the present teachings are illustrated. The first construction piece is referred to herein as a wheel assembly 10. The second construction piece is referred to herein as a support member 12. The wheel assembly 10 may be coupled to, and used in cooperation with, the support member 12 and another construction piece 14 in the form of a construction piece kit 15 (FIG. 12). The kit may include a plurality of wheel assemblies 10 and a plurality of support members 12 that can be used to build various structures and assemblies. According to one exemplary use, the wheel assembly 10 and the support member 12 may be used as part of a challenge-based innovation system in a physical or virtual environment to create games, learning opportunities and competitions between various users or groups of users of the construction pieces.

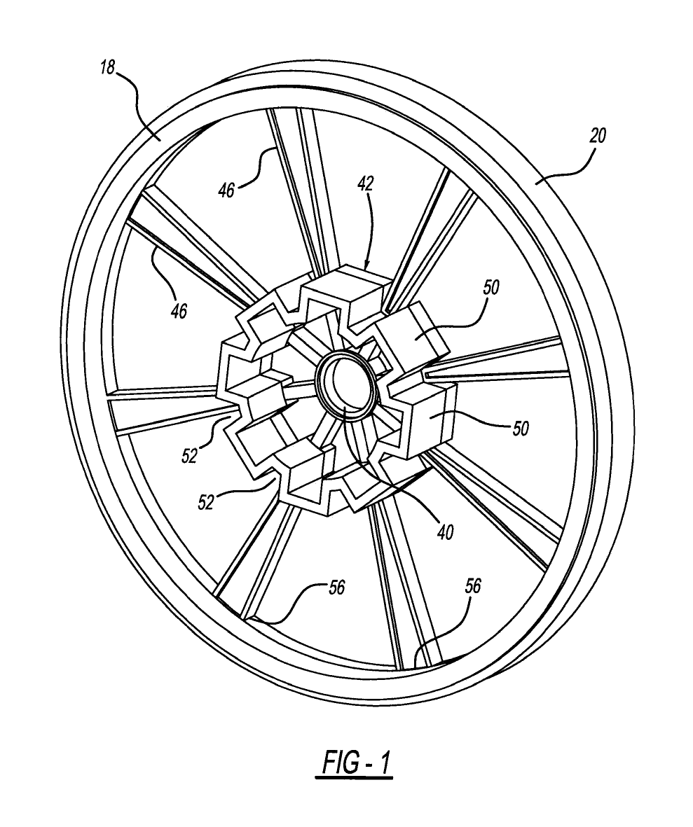

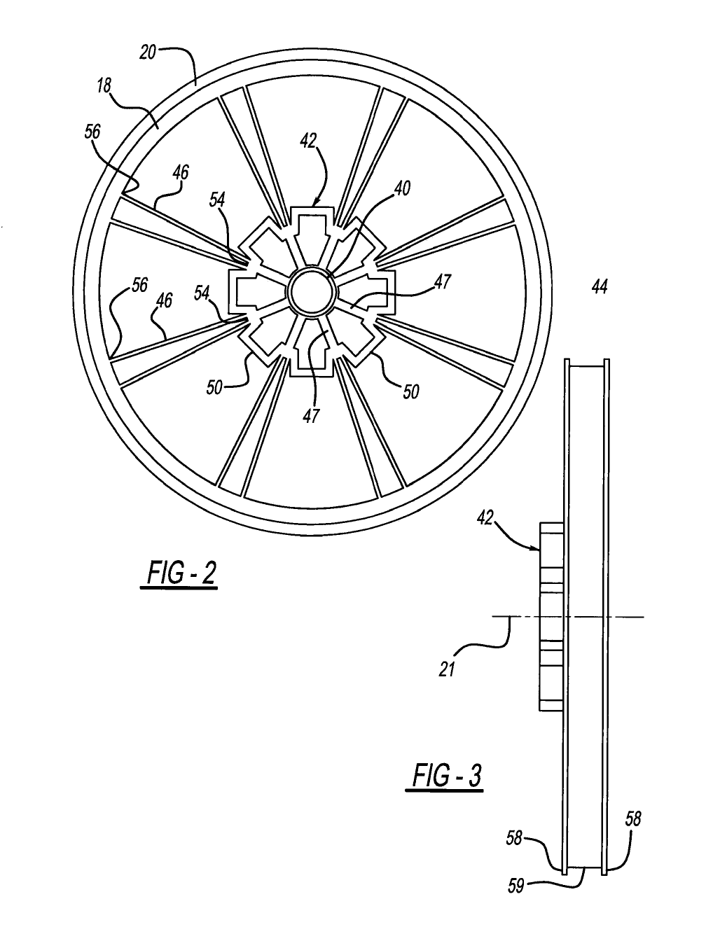

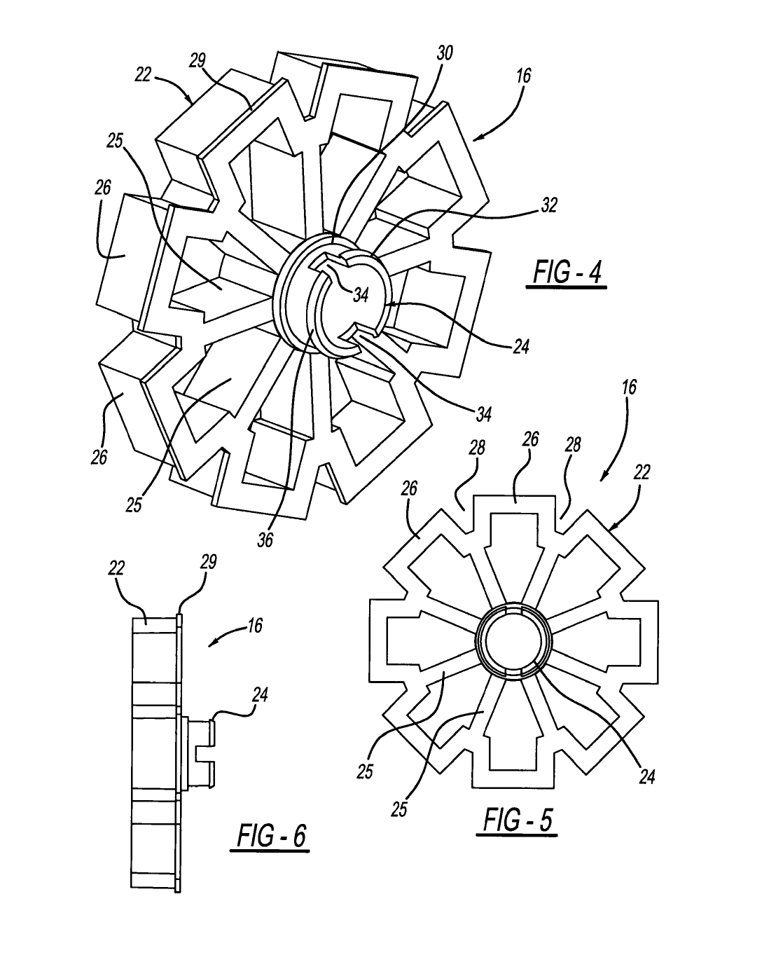

With reference to FIGS. 1 through 6, the wheel assembly 10 may include a hub member 16, a wheel member 18, and a band member 20, and may define a central axis 21. The hub member 16 may include a first mount portion 22 and a hub portion 24. The first mount portion 22 may allow the hub member 16 to be coupled to the support member 12 or to another wheel member 18.

The first mount portion 22 may be concentrically coupled to the hub portion 24 by a plurality of radially extending branches 25. The first mount portion 22 may define a plurality of radially extending spokes 26. In one configuration, the first mount portion 22 defines eight radially extending spokes 26, such that the first mount portion is substantially octolobular in shape. The spokes 26 may have a generally rectangular or square cross section, such that the first mount portion 22 defines a substantially triangular-shaped notch 28 between adjacent spokes 26. A flange 29 may be formed on an end of the spokes 26. In one configuration the flange 29 extends in the radial direction from each of the spokes 26, such that the flange 29 is a continuous peripheral flange formed around the whole of the first mount portion 22. The first mount portion 22 may have a maximum lateral width W1, defining a distance between opposing spokes 26.

The hub portion 24 may be a substantially cylindrical member extending from a proximal end 30 to a distal end 32 and having an outer diameter D1. The proximal end 30 may be integrally formed with the first mount portion 22. The hub portion 24 may include at least one axially extending notch 34 formed in the distal end 32. In one configuration, the hub portion 24 includes two opposed axially extending notches 34. The distal end 32 may include a radially extending flange 36.

With particular reference to FIGS. 1 through 3, the wheel member 18 may include a central hub 40, a second mount portion 42, an outer hub 44, and a plurality of spoke members 46. The central hub 40, the second mount portion 42, the outer hub 44 and the spoke members 46 may be integrally formed from plastic or another suitable material in an injection molding process. The central hub 40 may be rotatably and concentrically coupled to the hub member 16 for rotation about the central axis 21. The central hub 40 may have an inner diameter D2 that is greater than diameter D1, such that the hub member 16 is received within the central hub 40 The radially extending flange 36 may about an axial end of the central hub 40, such that the central hub 40 is fixed in the axial direction relative to the hub member 16.

The second mount portion 42 may be concentrically coupled to the central hub 40 by a plurality of radially extending branches 47. The first and second mount portions 22, 42 may be disposed on opposing sides of the wheel member 18. The second mount portion 42 may define a plurality of radially extending spokes 50. In one configuration, the wall 48 defines eight radially extending spokes 50, such that the second mount portion is substantially octolobular in shape. The spokes 50 may have a generally rectangular or square cross section, such that adjacent spokes 50 define a substantially triangular-shaped notch 52 therebetween. The second mount portion 42 may have a maximum lateral width W2, defining a distance between opposing spokes 50.

The spoke members 46 may extend in a radial direction from a proximal end 54 to a distal end 56. The proximal end 54 may be integrally formed with the spokes 50. Specifically, the proximal end 54 may extend from the triangular-shaped notch 52. The distal end 56 may be integrally formed with the outer hub 44, such that the outer hub 44 is concentric to the central hub 40. The spoke members 46 may have an I-beam shaped cross section. The proximal end 54 of the spoke members 46 may be wider than the distal end 56 of the spoke members. The outer hub 44 include opposed axially extending flanges 58 defining a circumferential channel 59 around the periphery of the outer hub.

The band member 20 may be disposed within, and removable from, the outer hub 44. In one configuration, the band member 20 is positioned within the channel 59 and a portion of the band member 20 extends radially beyond the flanges 58, such that the wheel assembly 10 has a maximum outer diameter D3. The band member 20 may be formed from rubber or a similar material.

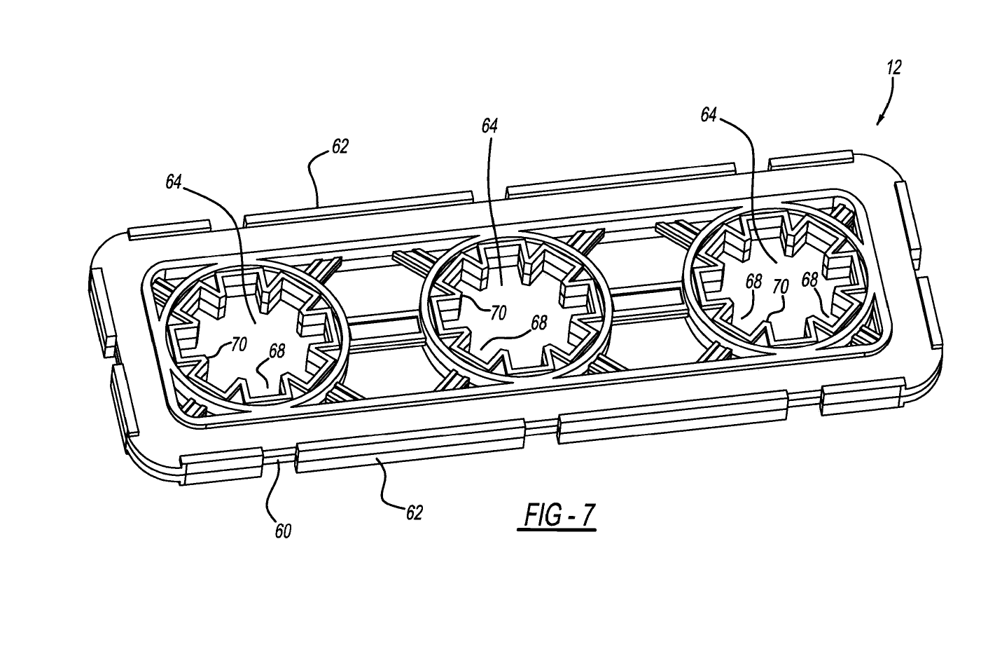

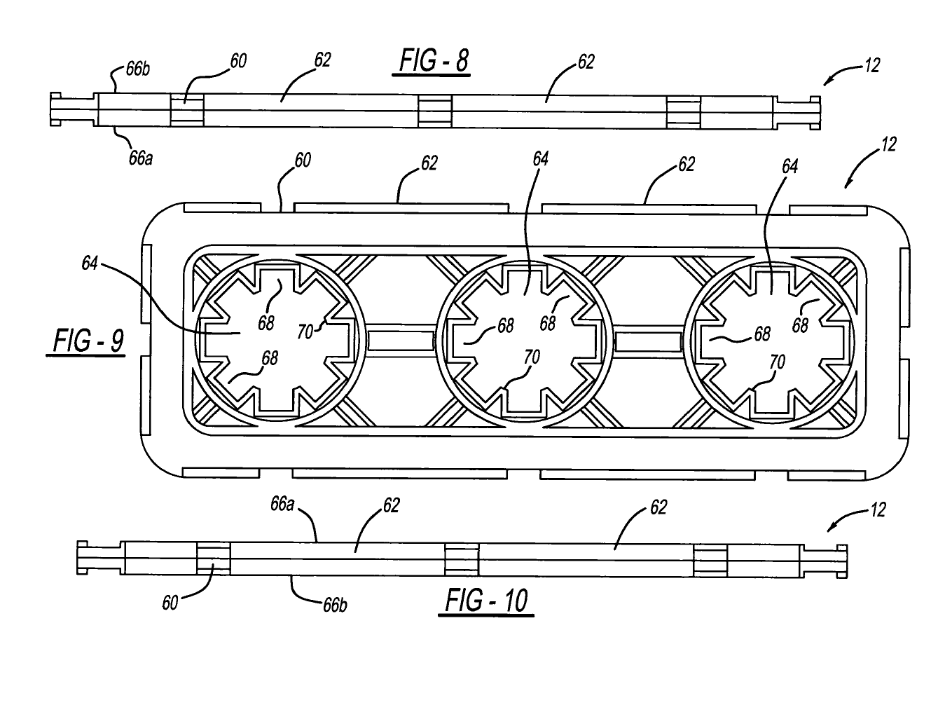

With reference to FIGS. 7 through 10, the support member 12 may be substantially rectangular having a length L greater than a width W2, as defined by an edge 60. The length L may be greater than the diameter D3 of the wheel assembly 10 and the width W2 may be less than the diameter D3 of the wheel assembly. The edge 60 may include at least one flange portion 62 and at least one third mount portion 64. The flange portion 62 and the mount portion 64 may allow the support member 12 to be coupled to the wheel assembly 10, or to another construction piece. In one configuration, the support member 12 includes twelve flange portions 62 and three third mount portions 64. The flange portions 62 may extend laterally away from first and second sides 66a, 66b of the support member 12.

The third mount portion 64 may be an aperture extending laterally between the first and second sides 66a, 66b. The third mount portions 64 may be arranged in a linear pattern and each third mount portion 64 may be equally spaced from the adjacent third mount portion 64. The third mount portion 64 may include a plurality of radially extending catches or detents 68. As illustrated, in one configuration, the third mount portion 64 includes eight detents 68, such that the third mount portion is substantially octolobular in shape. The detents 68 may have a substantially rectangular cross section, such that adjacent detents 68 define a radially extending tooth portion 70 therebetween. The radially extending tooth portion 70 may be substantially triangular. It will also be appreciated that the detents 68 may have other cross sections (e.g., triangular, circular, elliptical, etc.) within the scope of the present disclosure. The third mount portion 64 may have a maximum lateral width W3, defining a distance between opposing detents 68.

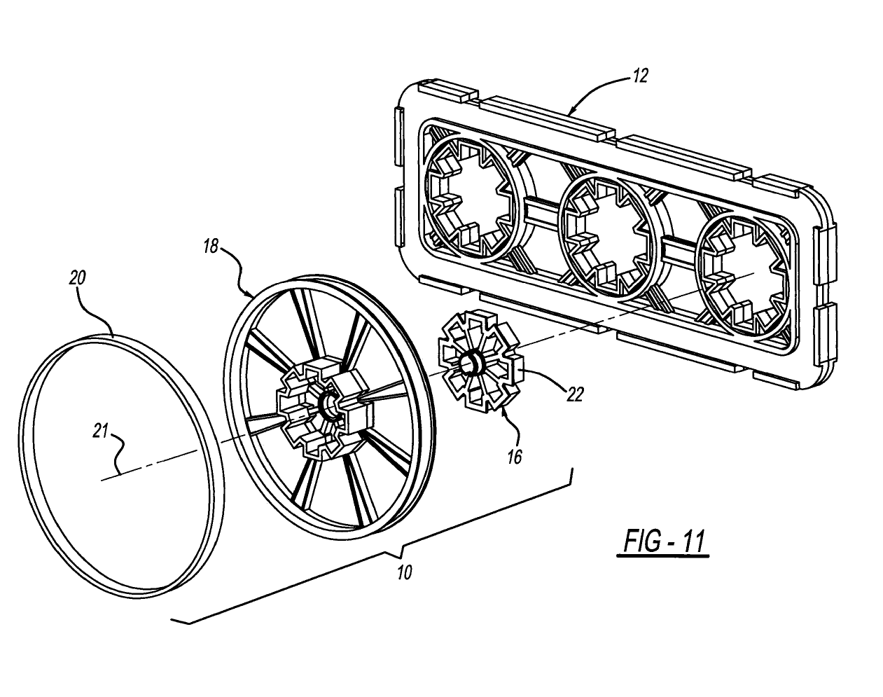

It will be appreciated that the first mount portion 22, the second mount portion 42, and the third mount portion 64 may be similarly shaped. Additionally, the width W3 may be equal to or slightly less than the width W1, such that the first and second mount portions 22, 42 can be located within the third mount portion 64. Accordingly, in one configuration, the wheel member 10 can be rotatably coupled to the support member 12 by coupling the first mount portion 22 to the third mount portion 64, as illustrated in FIGS. 11 and 12. In another configuration, the wheel member 10 can be fixedly coupled to the support member 12 by coupling the second mount portion 42 to the third mount portion 64.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A challenge-based innovation kit, comprising:
a first piece including a hub member and a wheel member rotatably coupled to the hub member, the hub member defining a first mount portion, and the wheel member defining a second mount portion opposing the first mount portion; and
a second piece including a plurality of third mount portions for coupling the second piece to the first mount portion or the second mount portion.

2. The challenge-based innovation kit of claim 1, wherein the first piece includes a first flange and a second flange, and wherein a band member is disposed between the first flange and the second flange.

3. The challenge-based innovation kit of claim 1, wherein the band member is a rubberized material.

4. The challenge-based innovation kit of claim 1, wherein the first mount portion includes a plurality of radially extending spokes and the third mount portion includes a plurality of radially extending detents, and wherein each spoke is received within one of the detents.

5. The challenge-based innovation kit of claim 4, wherein each spoke is substantially rectangularly shaped.

6. The challenge-based innovation kit of claim 1, wherein the wheel member includes a central hub, an outer hub and a plurality of spokes extending between the central hub and the outer hub.

7. The challenge-based innovation kit of claim 1, comprising a plurality of first pieces and a plurality of second pieces.

8. A challenge-based innovation kit, comprising:
a first piece including a hub member and a wheel member coupled to the hub member, the hub member defining a first octolobular mount portion, and the wheel member defining a second octolobular mount portion opposing the first mount portion; and
a second piece including a plurality of third octolobular mount portions for coupling the second piece to the first mount portion or the second mount portion.

9. The challenge-based innovation kit of claim 8, wherein the first octolobular mount portion is rotatable relative to the second octolobular mount portion.

10. The challenge-based innovation kit of claim 8, wherein the wheel member defines an outer hub portion, and wherein a rubberized band member is removably disposed on the outer hub portion.

11. The challenge-based innovation kit of claim 8, wherein the second piece is a substantially rectangular member having a width and a length.

12. The challenge-based innovation kit of claim 11, wherein the width of the second piece is less than the diameter of the wheel member and the length is greater of the second piece is greater than the diameter of the wheel member.

13. A method of conducting a challenge-based innovation system, the method comprising:
providing a plurality of users, including a leader;
providing each user with a challenge-based innovation kit including a plurality of interconnectable first pieces and second pieces;
posting a challenge assignment to a digital interface;
building a structure to solve the challenge assignment by interconnecting the first and second pieces;
working on solving the challenge assignment for a predetermined amount of time;
utilizing a third party to judge the structures and create a list of results, including a winning structure and losing structures;
posting the results to the digital interface; and
providing redeemable credits to the winning structure.

14. The method of claim 13, wherein the digital interface is a website.

15. The method of claim 13, wherein the digital interface is an application.

16. The method claim 13, wherein the assignment has a theme that is one of artistic, architectural, engineering and green.

17. The method of claim 13, wherein the credits are redeemable in an online store.
